(19) United States
(12) Patent Application Publication
(10) Pub. No.: US 2010/0000902 A1
(43) Pub. Date: Jan. 7, 2010

(54) COMPOSITE POLYMERIC MATERIALS FROM RENEWABLE RESOURCES

(75) Inventors: Danny H. Roberts, Clemson, SC (US); Joseph D. Gangemi, Seneca, SC (US); Dennis W. Smith, Seneca, SC (US)

Correspondence Address: DORITY & MANNING, P.A., POST OFFICE BOX 1449, GREENVILLE, SC, 29602-1449, US

(73) Assignee: Clemson University, Anderson, SC (US)

(21) Appl. No.: 11/887,698

(22) PCT Filed: Oct. 19, 2006
(86) PCT No.: PCT/US2006/041170

§ 371 Date: Sep. 21, 2009

Related U.S. Application Data
(60) Provisional application No. 60/729,099, filed on Oct. 21, 2005.

(51) Int. Cl. B65D 1/36; B65D 81/24; B32B 5/02; D03D 15/00; B29C 45/00; B29D 22/00

(52) U.S. Cl. 206/524.6; 428/221; 442/181; 264/328.1; 264/572

(57) ABSTRACT

Disclosed are environmentally friendly polymeric composite materials and products that can be formed from the composites. The polymeric composites can include a lactide-based polymeric matrix reinforced with fibers derived from renewable resources and optionally including one or more beneficial agents such as, for instance, naturally occurring UV blockers or absorbents, anti-oxidants, anti-microbials, and the like. The composite materials can be formed into a desired structure according to low energy formation processes and can be designed for controlled degradation. In one particular embodiment, the composite materials can be formed to produce containers for storing and protecting environmentally sensitive materials such as pharmaceuticals or nutraceuticals. Beneficially, the disclosed materials can be formed entirely from renewable resources.

The present application claims filing benefit of the provisional patent application having the Ser. No. 60/729,099 filed on Oct. 21, 2005, which is hereby incorporated by reference in its entirety.

The production of plastics from renewable resources has been a field of increasing interest for many years. One particular area of interest concerns the production of polyesters that may be formed from polymerization of lactic acid-based monomers. Specifically, ring-opening polymerization of lactide has shown promise in production of polymeric materials. Lactic acid-based materials are often of particular interest as the raw materials can be derived from renewable agricultural resources (e.g., corn, plant starches, and canes).

Various approaches have been taken in attempt to obtain lactide-based polymeric materials having desired product characteristics. For example, U.S. Pat. No. 5,744,516 to Hashitani, et al., U.S. Pat. No. 6,150,438 to Shiraishi, et al., U.S. Pat. No. 6,756,428 to Denesuk, and U.S. Pat. No. 6,869,985 to Mohanty, et al. all disclose various lactide-based polymers and methods of forming the lactide-based polymers.

While improvements have been made in the field and in particular in regard to the formation of lactide-based materials suitable for a variety of applications, room for improvement still remains. For example, in addition to the need for improved products in terms of strength characteristics, aesthetic characteristics, and the like, there is also a continuing need in the art to form more ecologically friendly products such as products completely formed from renewable resources. It would also be beneficial to form products via methods requiring less energy input than required for current methods.

Disclosed herein are polylactide-based composite materials that can include a polylactide-based polymer matrix, reinforcement fibers derived from a renewable resource such as flax, kenaf or cotton, and a protective inhibitory agent. An inhibitory agent can at least partially block or prevent the passage of a factor across a structure formed including the composite material and can, in one embodiment, improve the capability of the composite material in limiting or preventing the passage of a potentially damaging factor into the interior of a formed structure. For example, the composite material can at least partially prevent or restrict factors such as oxygen, ultraviolet (UV) radiation, microbial agents, fungal agents, and the like from passage across the wall of the structure.

A polymeric composite material can include a fibrous material in an amount of less than about 5% by weight of the composite material. In one embodiment, a polymeric composite material can include an inhibitory agent in an amount of between about 1 and about 100 μg/mL container volume for each month of storage life of a substance to be held in the container.

A polylactide-based polymer that can be used in a composite material as described herein can be, for instance, a polylactide-based homopolymer or copolymer or a polymer blend such as a polylactide/polyhydroxy alkanoate polymer blend.

Inhibitory agents can be derived from natural resources. One exemplary inhibitory agent can be a natural anti-oxidant such as turmeric. In one embodiment, an inhibitory agent can be released over time from the composite, for instance as the composite material degrades.

Structures that can be formed from a composite polymeric material can include containers, such as, for example, molded containers. A molded container can be, for example, an injection molded or an injection blow molded container. In one embodiment, a container as described herein can be completely biodegradable.

In another embodiment, disclosed is a packaging material for an agricultural product. The packaging material can include a polylactide-based polymer and reinforcement fibers formed of the same agricultural product as can be packaged with the material. For example, a packaging material can be a fabric that can include yarns formed of a polylactide-based composite material. In one preferred embodiment, the packaging material can be designed for use with cotton. The packaging material can also include an inhibitory agent as described above for additional protection of the contents to be held within the packaging material.

Also disclosed are methods for forming a polylactide-based composite material. Methods can include, for instance, providing a polylactide-based polymer resin having a moisture content of less than about 50 ppm, combining the resin with reinforcement fibers in an amount of less than about 5% by weight of the polymer, combining the polymer with an inhibitory agent, and then molding the mixture to obtain the final product.

A full and enabling disclosure, including the best mode, is set forth herein, including reference to the accompanying figures, in which:

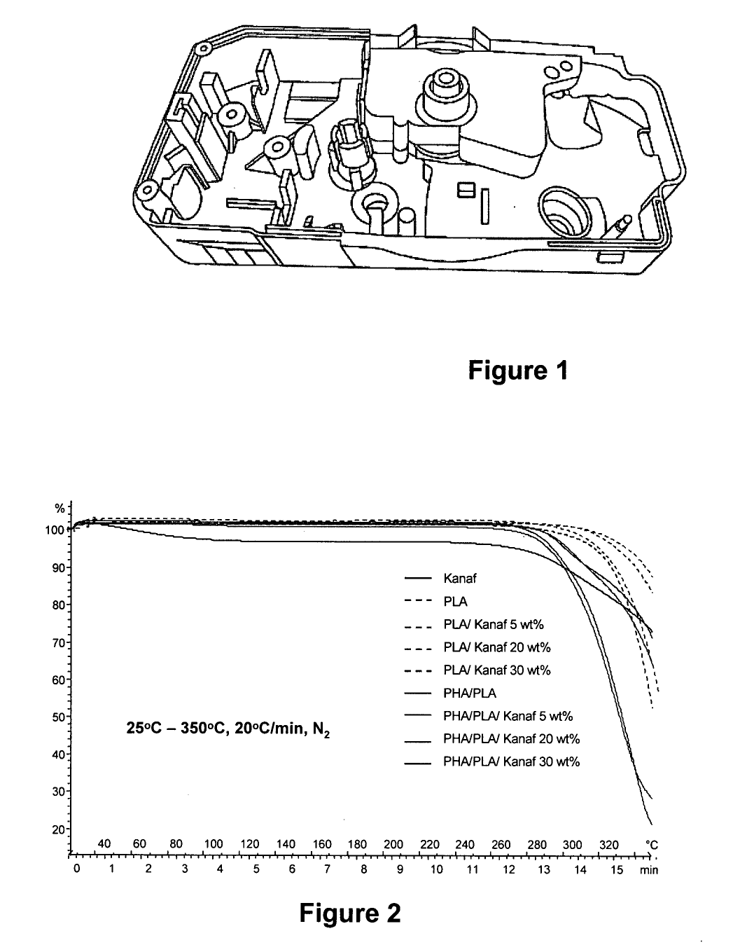

FIG. 1 illustrates an exemplary molded product formed from a composite material as disclosed herein;

FIG. 2 illustrates a thermal gravimetric analysis (TGA) of exemplary natural fibers that can be used in forming disclosed composites as well as TGA of several exemplary polymeric composite materials;

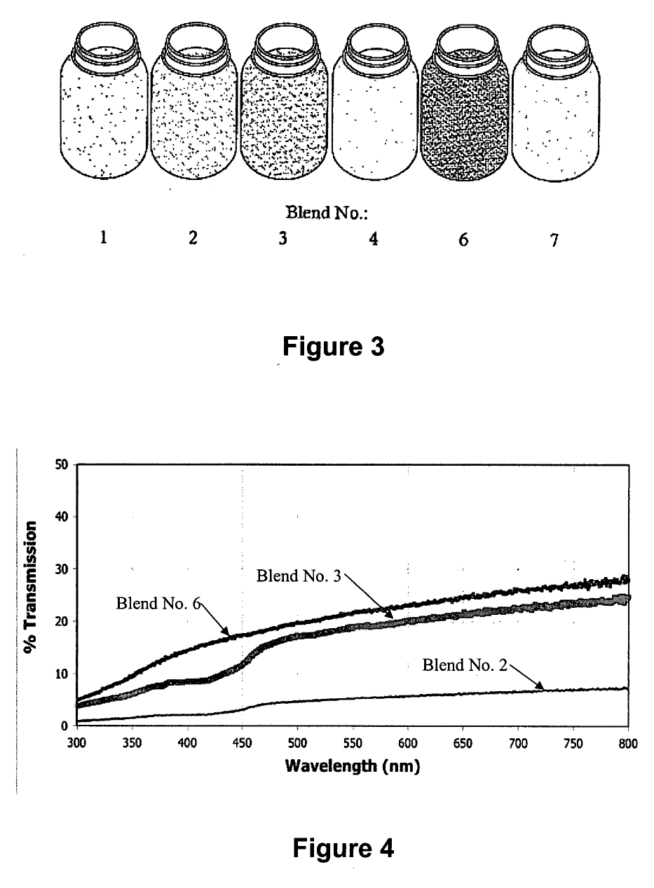

FIG. 3 illustrate several exemplary containers formed as described in the Example section;

FIG. 4 graphically illustrates energy transmission characteristics of containers formed as described in the Example section; and

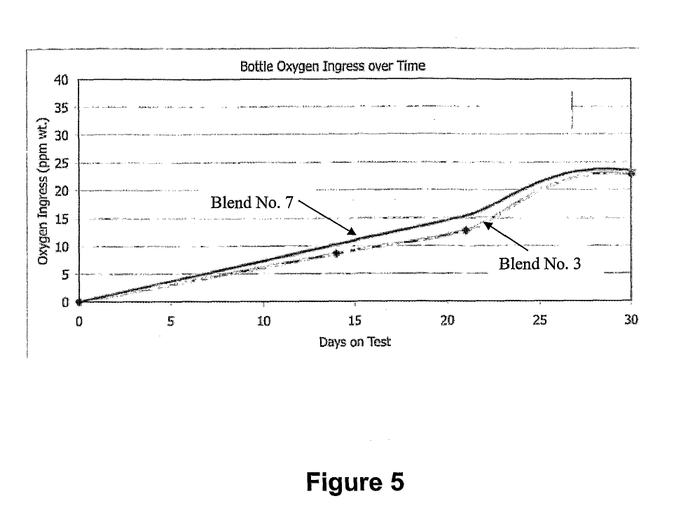

FIG. 5 graphically illustrates oxygen ingress over time for containers formed as described in the Example section.

Reference is made herein in detail to various embodiments of the disclosed subject matter, one or more examples of which are described herein. Each example is provided by way of explanation of the subject matter, not limitation thereof. In fact, it will be apparent to those skilled in the art that various modifications and variations can be made to the disclosed subject matter without departing from the scope or spirit of the disclosure. For instance, features illustrated or described as part of one embodiment, can be used with another embodiment to yield a still further embodiment.

In general, the present disclosure includes methods and materials that can be used to form environmentally-friendly polymeric materials as well as products that can be formed from such materials. In particular, disclosed polymeric composite materials can include a polymeric matrix in combination with a plurality of natural fibers. In one particular embodiment, all of the components of a composite material can be derived from renewable resources. Disclosed composite polymeric materials can be formed into any of a large variety of products via low temperature processing techniques. In such embodiments, both the materials and the methods used to form products from the materials can be environmentally friendly.

A composite polymeric material can include a lactide-based polymeric matrix in combination with a plurality of fibers, both of which can be derived from renewable resources. For purposes of this disclosure, the term ‘lactide-based polymer’ is intended to by synonymous with the terms polylactide, polylactic acid (PLA) and polylactide polymer, and is intended to include any polymer formed via the ring opening polymerization of lactide monomers, either alone (i.e., homopolymer) or in mixture or copolymer with other monomers. The term is also intended to encompass any different configuration and arrangement of the constituent monomers (such as syndiotactic, isotactic, and the like).

In addition to a polymeric matrix in combination with a plurality of natural fibers, the polymeric composites disclosed herein can include any of a variety of environmentally friendly beneficial agents such as, for instance, anti-oxidation agents, anti-microbial agents, anti-fungal agents, and the like that can provide desired characteristics to products. In one embodiment, beneficial agents can also be derived from renewable resources. For example, a polymeric composite can include one or more inhibitory agents that can provide a formed polymeric structure with an improved capability in preventing or limiting the passage of damaging factors into, through, or across the finished products.

In one particular embodiment, all of the components of a polymeric composite material, e.g., the polymers, the fibers, and any added agent(s), can be combined and processed to form blended lactide polymer resin in the form of beads or pellets. Accordingly, the pre-formed resin pellets can be ready for processing in a product fabrication process. As such, a product formation process can not only be a low cost, low energy formation process, but can also be quite simple.

In general, a lactide-based polymeric matrix can be derived from lactic acid. Lactic acid is produced commercially by fermentation of agricultural products such as whey, cornstarch, potatoes, molasses, and the like. When forming a lactide-based polymer, a lactide monomer can first be formed by the depolymerization of a lactic acid oligomer. In the past, production of lactide was a slow, expensive process, but recent advances in the art have enabled the production of high purity lactide at reasonable costs. As such processes are generally known to those of skill in the art; they are not discussed at length herein.

One embodiment of a formation process can include formation of a lactide-based polymer through the ring-opening polymerization of a lactide monomer. In other embodiments, commercially available polymers, such as those exemplified below, can be used.

In one embodiment, the lactide-based polymeric matrix of a composite material can include a homopolymer formed exclusively from polymerization of lactide monomers. For example, lactide monomer can be polymerized in the presence of a suitable polymerization catalyst, generally at elevated heat and pressure conditions, as is generally known in the art. In general, the catalyst can be any compound or composition that is known to catalyze the polymerization of lactide. Such catalysts are well known, and include alkyl lithium salts and the like, stannous octoate, aluminum isopropoxide, and certain rare earth metal compounds as described in U.S. Pat. No. 5,028,667 and which is incorporated herein by reference. The particular amount of catalyst used can vary generally depending on the catalytic activity of the material, as well as the temperature of the process and the polymerization rate desired. Typical catalyst concentrations include molar ratios of lactide to catalyst of between about 10:1 and about 100,000:1, and in one embodiment from about 2,000:1 to about 10,000:1. According to one exemplary process, a catalyst can be distributed in a starting lactide monomer material. If a solid, the catalyst can have a relatively small particle size. In one embodiment, a catalyst can be added to a monomer solution as a dilute solution in an inert solvent, thereby facilitating handling of the catalyst and its even mixing throughout the monomer solution. In those embodiments in which the catalyst is a toxic material, the process can also include steps to remove catalyst from the mixture following the polymerization reaction, for instance one or more leaching steps.

In one embodiment, a polymerization process can be carried out at elevated temperature, for example, between about 95° C. and about 200° C., or in one embodiment between about 110° C. and about 170° C., and in another embodiment between about 140° C. and about 160° C. The temperature can generally be selected so as to obtain a reasonable polymerization rate for the particular catalyst used while keeping the temperature low enough to avoid polymer decomposition. In one embodiment, polymerization can take place at elevated pressure, as is generally known in the art. The process typically takes between about 1 and about 72 hours, for example between about 1 and about 4 hours.

Polylactide homopolymer obtainable from commercial sources can also be utilized in forming the disclosed polymeric composite materials. For example, poly(L-lactic acid) available from Polysciences, Inc, Natureworks, LLC, Cargill, Inc., Mitsui (Japan), Shimadzu (Japan), or Chronopol can be utilized in the disclosed methods.

A lactide-based polymer matrix can include polymers formed from lactide monomer or oligomer in combination with one or more other polymeric materials. For example, in one embodiment, lactide can be co-polymerized with one or more other monomers or oligomers derived from renewable resources to form a lactide-based copolymer that can be incorporated in a polymeric composite material. According to such an embodiment, the secondary monomers of the copolymer can be materials that are at least recyclable and, in one embodiment, completely and safely biodegradable so as to present no hazardous waste issues upon degradation of the copolymer. In one particular embodiment, a lactide monomer can be co-polymerized with a monomer or oligomer that is anaerobically recyclable, which can improve the recyclability of the copolymer as compared to that of a PLA homopolymer. Polylactide copolymers for use in the disclosed composite materials can be random copolymers or block copolymers, as desired.

In another embodiment, a polymeric composition can include a polymer blend. For example, a lactide-based polymer or copolymer can be blended with another polymer, for example a recyclable polymer such as polypropylene, polyethylene terephthalate, polystyrene, polyvinylchloride or the like.

In one embodiment, a polymer blend can be utilized including a secondary polymer that can also be formed of renewable resources, as can be PLA. For example, a polymer blend can include a PLA polymer or copolymer in combination with a polyhydroxy alkanoate (PHA). PHAs are a member of a relatively new class of biomaterials prepared from renewable agricultural resources through bacterial fermentation. A variety of PHA compositions are available under the trade name NODAX™ from the Proctor & Gamble corporation of Cincinnatti, Ohio.

The relative proportions of polymers included in a blend can generally depend upon the desired physical characteristics of the polymeric products that can be formed from the composite materials. For example, a polymeric blend can include a PLA homopolymer or co-polymer as at least about 50% by weight of the polymer blend. In another embodiment, a polymeric blend can include at least about 70% PLA by weight of the blend, or higher in other embodiments, for instance greater than about 80% PLA by weight of the blend.

In addition to a lactide-based polymeric matrix, disclosed composite materials can also include a plurality of natural fibers that can be derived from renewable resources and can be biodegradable. Fibers of the composite materials can, in one embodiment, reinforce mechanical characteristics of the composite materials. For instance fibers can improve the strength characteristics of the materials. The natural fibers can offer other/additional benefits to the disclosed composites, such as improved compatibility with secondary materials, improved biodegradability of the composite materials, attainment of particular aesthetic characteristics, and the like.

Natural fibers suitable for use in the presently disclosed composites can include plant, mineral, and animal-derived fibers. Plant derived fibers can include seed fibers and multi-cellular fibers which can further be classified as bast, leaf, and fruit fibers. Plant fibers that can be included in the disclosed composites can include cellulose materials derived from agricultural products including both wood and non-wood products. For example, fibrous materials suitable for use in the disclosed composites can include plant fibers derived from families including, but not limited to dicots such as members of the Linaceae (e.g., flax), Urticaceae, Tiliaceae (e.g., jute), Fabaceae, Cannabaceae, Apocynaceae, and Phytolaccaceae families, and, in some embodiments, monocots such as those of the Agavaceae family.

In one embodiment, the fibers can be derived from plants of the Malvaceae family, and in one particular embodiment, those of the genera Hibisceae (e.g., kenaf, beach hibiscus, rosselle) and/or those of the genera Gossypieae (e.g., cottons and allies).

In one embodiment, cotton fibers can be utilized in the disclosed composites. In general, cotton fibers can first be separated from the seed and subjected to several mechanical processing steps as are generally known to those of skill in the art to obtain a fibrous material for inclusion in a composite.

In another embodiment, flax fibers can be incorporated into the disclosed composites. Processed flax fibers can generally range in length from 0.5 to 36 in with a diameter from 12-16 micrometers. Linseed, which is flax grown specifically for oil, has a well established market and millions of acres of flaxseed are grown annually for this application, with the agricultural fiber residue unused. Thus, agricultural production of flax has the potential to provide dual cropping, jobs at fiber processing facilities, and a value added crop in rotation.

Reinforcement fibers of a composite material can include bast and/or stem fibers extracted from plants according to methods generally known in the art. According to such embodiments, the inner pulp of a plant can be a useful by-product of the disclosed methods, as the pulp can beneficially be utilized in many known secondary applications, for instance in paper-making processes. For instance, the fibrous reinforcement materials can include bast fibers of up to about 10 mm in length. For example, kenaf bast fibers between about 2 mm and about 6 mm in length can be utilized as reinforcement fibers.

A composite polymeric material can generally include a fibrous component in an amount of up to about 50% by weight of the composite. For example, a composite material can include a fibrous component in an amount between about 10% and about 40% by weight of the composite. In one embodiment, a composite material can include a fibrous component in an amount of about 30% by weight of the composite.

According to one embodiment, the fiber component of the composite materials can serve merely to provide reinforcement to the polymeric matrix and improve strength characteristics of the material. In other embodiments, the fibrous component can optionally or additionally provide particular aesthetic qualities to the composite material and/or products formed therefrom. For example, particular fibers or combinations of fibers can be included in a composite material to affect the opacity, color, texture, and overall appearance of the material and/or products formed therefrom. For instance, cotton, kenaf, flax, as well as other natural fibers can be included in the disclosed composites either alone or in combination with one another to provide a composite material having a unique appearance and/or texture for any of a variety of applications.

In addition to a polymeric matrix and natural fibers, a polymeric composite material can include one or more inhibitory agents that can provide desirable characteristics to the material and/or products formed therefrom. For example, a composite can include one or more natural and/or biodegradable agents that can be derived from renewable resources such as anti-oxidants, anti-microbial agents, anti-fungal agents, ultra-violet blockers, ultra-violet absorbers, and the like that can be completely and safely biodegradable. In one exemplary embodiment, one or more inhibitory agents can improve protection of materials on one side of the formed polymeric material from one or more potentially damaging factors. For instance, one or more inhibitory agents can provide increased prevention of the passage of potentially harmful factors (e.g., oxygen, microbes, UV light, etc.) across a structure formed of the composite material and thus offer improved protection of materials held on one side of the composite polymeric material from damage or degradation. In one embodiment, a composite polymeric material can be designed to release an inhibitory agent from the matrix as the composite degrades, at which time the inhibitory agent can provide the desired activity, e.g., anti-microbial activity, at a surface of the polymeric composite.

Exemplary inhibitory agents can include without limitation, one or more natural anti-oxidants such as turmeric, burdock, green tea, garlic, bilberry, elderberry, ginkgo biloba, grape seed, milk thistle, lutein (an extract of egg yolks, corn, broccoli, cabbage, lettuce, and other fruits and vegetables), olive leaf, rosemary, hawthorn berries, chickweed, capsicum (cayenne), and blueberry pulp.

One or more natural anti-microbial agents can be included in a polymeric composite. For example, exemplary natural anti-microbial agents can include berberine, an herbal anti-microbial agent that can be extracted from plants such as goldenseal, coptis, barberry, Oregon grape, and yerba mensa. Other natural anti-microbial agents can include, but are not limited to, extracts of propolis, St. John's wort, cranberry, garlic, E. cochinchinensis and S. officinalis, as well as anti-microbial essential oils, such as those that can be obtained from cinnamon, clove, or allspice, and anti-microbial gum resins, such as those obtained from myrrh and guggul.

Other exemplary inhibitory agents that can be included in the composite materials can include natural anti-fungal agents such as, for example, tea tree oil and resveratrol (a phytoestrogen found in grapes and other crops), or naturally occurring ultraviolet light blocking compounds such as mycosporine-like amino acids found in coral.

Optionally, the composite polymeric materials can include multiple inhibitory agents, each of which can bring one or more desired protective capacities to the composite.

In general, an inhibitory agent such as those described above can be included in an amount of less than about 10% by weight of the composite material. In other embodiments, an agent can be included at higher weight percentage. In one embodiment, the preferred addition amount can depend on one or more of the activity level of the agents upon potentially damaging factors, the amount of material to be protected by a structure formed including the composite material, the expected storage life of the material to be protected, and the like. For example, in one embodiment, an inhibitory agent can be incorporated into a composite polymeric material in an amount of between about 1 μg/mL material to be protected/month of storage life to about 100 μg/mL material to be protected/month of storage life.

Beneficially, as the formation processes can be carried out at low processing temperatures as discussed in more detail below, many natural inhibitory agents can be successfully incorporated in the composite materials. In particular, inhibitory agents in which the desired activity could be destroyed during the high-temperature processing conditions necessary for many previously known composite materials can be successfully included in the disclosed materials as they can maintain the desired activity throughout the formation processes.

A composite polymeric material can optionally include one or more additional additives as are generally known in the art. For example, a small amount (e.g., less than about 5% by weight of the composite material) of any or all of plasticizers, stabilizers, fiber sizing, polymerization catalysts, or the like can be included in the composite formulations. In one embodiment, any additional additives to the composite materials can be at least recyclable and non-toxic, and, in one embodiment, can be formed from renewable resources.

The various components of a polymeric composite material can be suitably combined prior to forming a polymeric structure. For instance, in one embodiment, the components can be melt or solution mixed in the formulation desired in a formed structure and then formed into pellets, beads, or the like suitable for delivery to a formation process. According to this particular embodiment, a product formation process can be quite simple, with little or no measuring or mixing of components necessary prior to the formation process (e.g., at the hopper).

In one particular embodiment, a chaotic mixing method such as that described in U.S. Pat. No. 6,770,340, to Zumbrunnen, et al., which is incorporated herein by reference, can be used to combine the components of the polymeric composite. A chaotic mixing process can be used, for example, to provide the composite material with a particular and selective morphology with regard to the different phases to be combined in the mixing process, and in particular, with regard to the polymers, the fibrous reinforcement materials, and the inhibitory agents to be combined in the mixing process. For example, a chaotic mixing process can be utilized to form a composite material including one or more inhibitory agents concentrated at a predetermined location in the composite, so as to provide for a controlled release of the agents, for instance a timed-release of the agents from the composite as the polymeric component of the composite material degrades over time.

Following combination of the various components, the composite polymeric material can be formed into a desired structure via a low energy formation process.

One exemplary formation process can include providing the components of the composite materials to a product mold and forming the product via an in situ polymerization process. According to this method, reinforcement fibers, one or more inhibitory agents, and the desired monomers or oligomers can be solution mixed or melt mixed in the presence of a catalyst, and the polymeric product can be formed in a single step in situ polymerization process. In one embodiment, an in situ polymerization formation process can be carried out at ambient or only slightly elevated temperatures, for instance, less than about 75° C. Accordingly, the activity of the inhibitory agents can be maintained through the formation process, with little or no loss in activity.

In situ polymerization can be preferred in some embodiments due to the more favorable processing viscosity and degree of mixing that can be attained. For example, a monomer solution can describe a lower viscosity than a solution of the polymerized material. Accordingly, a reactive injection molding process can be utilized with a low viscosity monomer solution though the viscosity of the polymer is too high to be processed similarly. In addition, better interfacial mixing can occur by polymerization in situ in certain embodiments, and better interfacial mixing can in turn lead to better and more consistent mechanical performance of the final molded structure.

A formation process can include forming a polymeric structure from a polymeric melt, for instance in an extrusion molding process, an injection molding process or a blow molding process. For purposes of the present disclosure, injection molding processes include any molding process in which a polymeric melt or a monomeric or oligomeric solution is forced under pressure, for instance with a ram injector or a reciprocating screw, into a mold where it is shaped and cured. Blow molding processes can include any method in which a polymer can be shaped with the use of a fluid and then cured to form a product. Blow molding processes can include extrusion blow molding, injection blow molding, and stretch blow molding, as desired. Extrusion molding methods include those in which a melt is extruded from a die under pressure and cured to form the final product, e.g., a film or a fiber.

When considering processes that include forming a structure from a melt, polymeric structures can be formed utilizing less energy than previously known melt processes. For example, melts can be processed at temperatures about 100° F. lower than molding temperatures necessary for polymers such as polypropylene, polyvinyl chloride, polyethylene, and the like. For instance, composite polymeric melts as disclosed herein can be molded at temperatures between about 170° C. to about 180° C., about 100° C. less than many fiberglass/polypropylene composites.

In one embodiment, a composite polymeric material as disclosed herein can be formed as a container, and in one particular embodiment, a container suitable for holding and protecting environmentally sensitive materials such as biologically active materials including pharmaceuticals and nutraceuticals. For purposes of the present disclosure, the term ‘pharmaceutical’ is herein defined to encompass materials regulated by the United States government including, for example, drugs and other biologics. For purposes of the present disclosure, the term ‘nutraceutical’ is herein defined to refer to biologically active agents that are not necessarily regulated by the United States government including, for example, vitamins, dietary supplements, and the like.

As discussed above, a polymeric composite material can include one or more inhibitory agents that can prevent passage of one or more factors across a formed structure. Accordingly, the polymeric composite material can help to prevent the degradation of the contents of a container from damage due to for instance, oxidation, ultraviolet energy, and the like. For example, formed structures can include a natural anti-oxidant in the composite polymeric material and can be utilized to store and protect oxygen-sensitive materials, such as oxygen-sensitive pharmaceuticals or nutraceuticals, from oxygen degradation.

Formed structures incorporating the composite materials can include laminates including the disclosed composite materials as one or more layers of the laminate. For example, a laminate structure can include one or more layers formed of composite materials as herein described so as to provide particular inhibitory agents at predetermined locations in the laminate structure. Such an embodiment can, for instance, provide for a controlled release of the inhibitory agents, for instance a timed-release of an agent from the composite as the adjacent layers and the polymeric component of the composite material degrade over time.

In another embodiment, a laminate can include an impermeable polymeric layer on a surface of the structure, e.g., on the interior surface of a container (e.g., bottle or jar) or package (e.g., blister pac for pills). In one particular embodiment, an extruded film formed from a composite polymeric material can form one or more layers of such a laminate structure. For example, an impermeable PLA-based film can form an interior layer of a container so as to, for instance, prevent leakage, degradation or evaporation of liquids that can be stored in the container. Such an embodiment may be particularly useful when considering the storage of alcohol-based liquids, for instance, nutraceuticals in the form of alcohol-based extracts or tinctures.

In another embodiment, a composite polymeric material can form a structure to contain and protect environmentally sensitive materials such as environmentally sensitive agricultural materials including processed or unprocessed crops. For example, a composite polymeric material can be melt processed to form a fiber or a yarn and the fibers or yarns can be further processed to form a fabric, for instance a woven, nonwoven, or knitted fabric, that can be utilized to protect and/or contain an environmentally sensitive material such as a recently harvested agricultural material or optionally a secondary product formed from the agricultural material.

In one embodiment, containers can be specifically designed for the agricultural material that they will protect and contain. For instance, containers can be particularly designed to contain a specific agricultural material, and the fibrous component of the composite used to form the container can be derived from that same agricultural material. For example, a composite polymeric material can include a degradable polymeric matrix and a plurality of cotton fibers. This composite material can then be melt processed to form a structure, e.g., a bag, a wrap, or the like specifically designed to contain and/or protect cotton. Similarly, a composite polymeric material can include a degradable, PLA-based polymeric component and a fibrous flax component, and the composite can form a container specifically designed for the containment/protection of either unprocessed or processed flax.

According to such an embodiment, even should the container be damaged, for instance punctured in the course of handling such that the contents come into contact with a portion of the container material, the contents, e.g., the cotton, flax, etc., can still be suitable and safe for further processing, in particular as the ‘contaminants’ that have inadvertently come into contact with the contents are naturally derived materials, and in the case of the fibrous components, derived from the same crop as the contents of the container.

The presently disclosed subject matter may be more clearly understood with reference to the examples, below.

### EXAMPLE 1

### Solution Blending of Polylactide/Kenaf Composites

A 100 mL single neck flask was dried under flame and connected to an overhead stir. To this flask, various amounts of commercial L-polylactide polymer (obtained from Cargill Dow Polymers, LLC, MW ca. 190,000 Mn) as indicated in Table 1, below, and 30 mL of Tetrahydrofuran (THF) were added and stirred until the polymer pellets were completely dissolved. After forming a homogeneous solution, various amounts of Kenaf fiber (2-5 mm) were added to the solution in separate runs, as indicated below in Table 1. In addition, a control sample including no fiber addition was formed. In each case, following addition of the fibers, the PLA/kenaf mixture was stirred for 2 hr. The resulting solution was added to a Teflon mold and dried on the bench top overnight followed by drying under vacuum at 40° C. for 1 hr.

The tensile strengths of the composite materials were measured at room temperature with Instron instrument model 1125. Tensile test specimens with 6.5 cm×2.5 cm×0.2 cm specifications were used. For each reading three samples were used and average value was taken. For all experiments 20 mm/min crosshead speed was used.

TABLE 1

| | Polymer | Fiber | | |
|---|---|---|---|---|
| Sample No. | added (g) | added(g) | wt % fiber | Modulus (MPa) |
| 1 | 10 | 0 | 0 | 352.0 |
| 2 | 10 | 1.12 | 10 | 410.96 |
| 3 | 10 | 2.5 | 20 | 761.99 |
| 4 | 10 | 4.28 | 30 | 575.75 |
| 5 | 7.0 | 7.0 | 50 | 340.39 |

### EXAMPLE 2

### Melt Blending of Polylactide/Kenaf Composites

Various amounts of Polylactide polymer were melt-blended with various amounts of Kenaf fiber (2-5 mm) with a Thermo Haake Mini Lab twin extruder, as indicated below in Table 2. The mixing temperature was 170° C. and mixing was carried out for 5 minutes. In addition, a control sample including no fiber was formed. The resulting melt was compression molded with a Carver Laboratory press. Specifically, the samples were compression molded between two Teflon sheets under 1000 pounds force at 170° C. for 1 min. Specimens were then cooled to room temperature.

The tensile strengths of the composite materials were measured as described above for Example 1. Results are shown below in Table 2.

TABLE 2

| | Polymer | Fiber | | |
|---|---|---|---|---|
| Sample No. | added (g) | added(g) | wt % fiber | Modulus (MPa) |
| 1 | 10 | 0 | 0 | 624.81 |
| 2 | 10 | 0.52 | 5 | 712.12 |
| 3 | 10 | 1.12 | 10 | 841.53 |
| 4 | 10 | 2.5 | 20 | 881.23 |
| 5 | 10 | 4.28 | 30 | 901.99 |
| 6 | 7 | 7 | 50 | 777.57 |

### EXAMPLE 3

### Melt Blending of Polylactide/PHA/Kenaf composites

Various amounts of Polylactide polymer were blended with a commercially available PHA polymer (NodaX™ available from the Procter & Gamble Co. of Cincinnati, Ohio) and Kenaf fiber (2-5 mm) with a Thermo Haake Mini Lab twin extruder, as indicated below in Table 3. The mixing temperature was 170° C. and mixing was carried out for 5 minutes. In addition, a control sample including no fiber was formed. The resulting melt was compression molded with a Carver Laboratory press. Specifically, the samples were compression molded between two Teflon sheets under 1000 pounds force at 170° C. for 1 min. Specimens were then cooled to room temperature on the bench top.

The tensile strengths of the composite materials were measured as described above for Example 1. Results are shown below in Table 3.

TABLE 3

| Sample | PLA | PHA | Fiber | | Modulus |
|---|---|---|---|---|---|
| No. | added (g) | added (g) | added(g) | wt % fiber | (MPa) |
| 1 | 10 | 1 | 0 | 0 | 650.13 |
| 2 | 10 | 1 | 0.55 | 5 | 682.8 |
| 3 | 10 | 1 | 1.1 | 10 | 980.2 |
| 4 | 7 | 0.7 | 3.3 | 30 | 985.64 |

As can be seen, for both melt- and solution-formed composites, increase of Kenaf fiber loading levels enhanced the tensile modulus up to a loading level of about 30%. For both melt blends and solution blends, the tensile modulus values began to drop at higher Kenaf loading levels.

### EXAMPLE 4

Several exemplary composite materials were formed and tested for a variety of characteristics as follows:

Moisture and Alcohol Resistance. Thin films of kenaf/PLA composites (containing 5 and 30 wt % kenaf) were submerged in absolute alcohol and a 10 wt % aqueous solution of alcohol over the period of two months. No weight loss or swelling was observed.

Processability and Moldability. Initial investigations have been carried out into the processability and moldability of PLA/kenaf composite materials. PLA/kenaf composites (30 wt % kenaf) were successfully molded into various geometries with good structural integrity (FIG. 1).

Thermal Stability of the Natural Fiber/PLA Composites. Thermal gravimetric analysis (TGA) was used to determine the thermal stability kenaf/PLA/PHA and kenaf/PLA composites, results are shown in FIG. 2. Kenaf, PLA, PHA and composites were dynamically heated to 400° C. at a heating rate of 20° C./minute under N₂ and thermal stability was observed. The kenaf natural fiber and PLA composites began degrading at 260° C. and 300° C., respectively. PLA/PHA (10 wt % of PHA, based on PLA) exhibited a much higher thermal degradation compared to PLA alone. PLA/kenaf composites, however, surprisingly exhibited a much higher thermal stability compared to kenaf fiber alone. This is an excellent indication of a good fiber coating by the PLA polymer. Increase of the fiber content led to a higher weight loss at elevated temperatures.

### EXAMPLE 5

Cotton and kenaf fibers were blended with PLA and an optional natural anti-oxidant additive (turmeric). The blends thus formed were then utilized to fabricate blow molded containers.

Table 4, below, lists the different material blends that were prepared and molded according to the process. All materials were prepared with virgin PLA, product number 7032D, obtained from NatureWorks® LLC. All addition amounts are given as a weight percent unless otherwise noted.

TABLE 4

| Blend No. | Fibers | Anti-oxidant |
|---|---|---|
| 1 | 3% Cotton | 0.1% Turmeric |
| 2 | 3% Cotton | 0.1% Turmeric |
| 3 | 3% Kenaf | 0.1% Turmeric |
| 4 | 3% Cotton | 0.1% Turmeric |
| 5 | 3% Cotton | 0 |
| 6 | 3% Kenaf | 0 |
| 7 | 3% Cotton | 0 |

To prepare blend nos. 1, 2, and 5, the cotton was first placed into shallow pans, and PLA was run through a twin-screw onto the cotton. The volume of cotton required to create a 3% blend with PLA was significantly larger than the volume of the PLA material due to the difference in bulk densities of the materials. The cotton and turmeric (when present) was manually mixed into the PLA by hand, allowed to cool and cryogenically ground through a 4 mm screen. The material was tumbled with virgin PLA and placed in the hood of the twin-screw. Material was manually forced in the feeder.

The cotton/PLA blends of material blend nos. 4 and 7 were prepared via a solution blending process as described above in Example 1 for a PLA/kenaf blend. The blends were then manually fed into the feeder.

To prepare blend nos. 3 and 6, kenaf was chopped several times to obtain fibers approximately ¼ inch in length. The material was then filtered through a mesh screen. The material remaining following filtering was chopped and filtered again until suitable amount of fiber was obtained. The kenaf fibers and virgin PLA (and turmeric for blend no. 3) were mixed through simultaneous addition to a Mylar bag followed by manual shaking. As with the cotton blends, the material was manually fed into the twin-screw.

For each blend, the resin was dried at 100° C. overnight to reduce the moisture level below 50 ppm. Feed materials were ground into small particle sizes before extrusion.

### Extrusion of Preforms

Injection molding conditions were established as described in Table 5, below, to optimize a preform. Preforms were molded on an Arburg 320M unit cavity injection molding machine. Table 5 lists the temperature set points for the twin-screw extrusion process that varied depending upon the fiber type of the blend. After extrusion, the resins were brown in color with the kenaf blends appearing darker. The fibers were visible in the strands and pellets that were produced. Both resin types were brittle.

TABLE 5

| | |
|---|---|
| Zone Temperature | Fiber type |

| (° C.) | Cotton Blends | Kenaf Blends |
|---|---|---|
| Zone 1 | 160 | 160 |
| Zone 2 | 170 | 170 |
| Zone 3 | 180 | 180 |
| Zone 4 | 190 | 190 |
| Zone 5 | 200 | 200 |
| Screw Speed (rpm) | 125 | 125 |

Conditions used to mold each different blend are detailed in Table 6, below. As can be seen, the conditions were changed among the various blends. The preforms of blends including kenaf were darker than those with cotton. Preforms containing turmeric were darker yet and had a yellow hue.

TABLE 6

| Blend No. | 1 | 2 | 3 | 4 | 5 | 6 | 7 |
|---|---|---|---|---|---|---|---|
| Relative Humidity | 29% | 29% | 29% | 29% | 29% | 29% | 29% |
| Dew Point (° F.) | 36.4 | 36.4 | 36.4 | 36.4 | 36.4 | 36.4 | 36.4 |
| Mold Temp (° F.) | 65 | 65 | 90 | 75 | 75 | 90 | 75 |
| Ambient Temp (° F.) | 70.5 | 70.5 | 70.5 | 70.5 | 70.5 | 70.5 | 70.5 |
| Barrel Temperatures | | | | | | | |
| Feed (° C.) | 191 | 191 | 179 | 191 | 191 | 182 | 191 |
| Zone 2 (° C.) | 197 | 197 | 183 | 190 | 197 | 185 | 191 |
| Zone 3 (° C.) | 193 | 193 | 185 | 196 | 193 | 188 | 196 |
| Zone 4 (° C.) | 193 | 193 | 189 | 196 | 193 | 188 | 196 |
| Nozzle (° C.) | 190 | 190 | 191 | 195 | 190 | 191 | 192 |
| Injection | | | | | | | |
| Injection Pressure 1 (bar) | 800 | 800 | 900 | 900 | 800 | 900 | 900 |
| Injection Time (sec) | 2.2 | 2.2 | 1.8 | 2.3 | 2.2 | 1.8 | 2.2 |
| 1st Injection Speed | 12.0 | 12.0 | 12.0 | 12.0 | 12.0 | 12.0 | 12.0 |
| (ccm/sec) | | | | | | | |
| 2nd Injection Speed | 8.0 | 8.0 | 10.0 | 8.0 | 8.0 | 10.0 | 8.0 |
| (ccm/sec) | | | | | | | |
| Holding Pressure | | | | | | | |
| Switch-Over Point (ccm) | 9.0 | 9.0 | 6.0 | 9.0 | 9.0 | 6.0 | 9.0 |
| 1st Hold Pressure (bar) | 100.0 | 100.0 | 100.0 | 350.0 | 100.0 | 100.0 | 350.0 |
| 2nd Hold Pressure (bar) | 250.0 | 250.0 | 200.0 | 250.0 | 250.0 | 200.0 | 250.0 |
| 3rd Hold Pressure (bar) | 250.0 | 250.0 | 250.0 | 250.0 | 250.0 | 250.0 | 250.0 |
| 1st Hold Pr. Time (sec) | 0.5 | 0.5 | 0.5 | 0.5 | 0.5 | 0.5 | 0.5 |
| 2nd Hold Pr. Time (sec) | 2.0 | 2.0 | 2.0 | 2.0 | 2.0 | 2.0 | 2.0 |
| 3rd Hold Pr. Time (sec) | 2.0 | 2.0 | 2.0 | 2.0 | 2.0 | 2.0 | 2.0 |
| Remain Cool Time (sec) | 10.0 | 10.0 | 12.0 | 10.0 | 10.0 | 12.0 | 10.0 |
| Dosage | | | | | | | |
| Circumf. Speed (m/min) | 15.0 | 15.0 | 15.0 | 15.0 | 15.0 | 15.0 | 15.0 |
| Back Pressure (bar) | 25.0 | 25.0 | 25.0 | 25.0 | 25.0 | 25.0 | 25.0 |
| Dosage Volume (ccm) | 25.0 | 25.0 | 25.0 | 25.0 | 25.0 | 25.0 | 25.0 |
| Meas. Dosage Time | 2.0 | 2.0 | 2.2 | 3.0 | 2.0 | 2.2 | 3.2 |
| (sec) | | | | | | | |
| Cushion (ccm) | 9.0 | 9.0 | 5.9 | 8.9 | 9.0 | 5.9 | 8.9 |
| Adjustment Data | | | | | | | |
| Cycle Time (sec) | 23.2 | 23.5 | 25.4 | 22.0 | 23.5 | 25.4 | 23.5 |

### Blow Molding

Preforms molded from the blends described above were blown into a 10 oz unit cavity mold using a Sidel SBO machine.

The blow molding process for each sample is detailed in Table 7, below. The individual lamp settings were adjusted to provide less heat in the end cap and body, and more in the top. The base of the bottle formed of blend no. 1 was additionally quenched in an ice bath. FIG. 3 illustrates several of the blow molded bottles obtained.

TABLE 7

| Blend No. | 1 | 2 | 3 | 4 | 5 | 6 | 7 |
|---|---|---|---|---|---|---|---|
| Speed (bph) | 600 | 600 | 600 | 600 | 600 | 600 | 600 |
| Overall Oven Lamp Settings | 40 | 45 | 45 | 30 | 45 | 45 | 40 |
| Zone 6 | 35 | 0 | 0 | 0 | 0 | 0 | 0 |
| Zone 5 | 35 | 30 | 30 | 35 | 30 | 30 | 30 |
| Zone 4 | 50 | 40 | 40 | 35 | 40 | 40 | 40 |
| Zone 3 | 50 | 40 | 40 | 35 | 40 | 40 | 40 |
| Zone 2 | 50 | 50 | 50 | 50 | 50 | 50 | 50 |
| Zone 1 | 100 | 100 | 100 | 100 | 100 | 100 | 100 |
| Stretching Speed | 0.9 | 1.5 | 1.5 | 1.5 | 1.5 | 1.5 | 1.5 |
| Preform Temp. (° C.) | 97 | 92 | 90 | 68 | 89 | 89 | 89 |
| Blow Timing/Pressures | | | | | | | |
| Cycle Time | 3.39 | 3.35 | 3.35 | 3.35 | 3.35 | 3.35 | 3.35 |
| Low Blow Position (mm) | 155 | 173 | 173 | 173 | 173 | 173 | 173 |
| Low Pressure (bar) | 7 | 6.5 | 6.5 | 6.5 | 6.5 | 6.5 | 6.5 |
| High Blow Position (mm) | 195 | 210 | 210 | 210 | 210 | 210 | 210 |
| High Blow Pressure (bar) | 40 | 40 | 40 | 40 | 40 | 40 | 40 |
| Preblow Flow (bar) | 3 | 0 | 0 | 3 | 0 | 0 | 3 |
| Body Mold Temp (° F.) | 40 | 40 | 40 | 40 | 40 | 40 | 40 |
| Base Mold Temp. (° F.) | 40 | 40 | 40 | 40 | 40 | 40 | 40 |
| Top Wt (g) | 7.7 | 8.1 | 8.4 | 8.1 | 8.2 | 8.2 | 8.1 |
| Panel Wt (g) | 6.7 | 6.3 | 6 | 6 | 6.4 | 6.4 | 6 |
| Base Wt (g) | 6.2 | 4.8 | 5.1 | 5.2 | 4.9 | 4.9 | 5.2 |

### Bottle Testing

Following formation, bottles were analyzed for UV transmission between 300 and 400 nm using a Perkin-Elmer Lambda 9 UV/Vis/NIR Spectrophotometer. Beer-Lambert's law was used to correct the data to a 0.012″ thickness that is the common wall thickness for PET bottles. Three sets of PLA containers were evaluated for UV transmission: blend no. 2, blend no. 3 and blend no. 6. Results are illustrated in Table 8 and in FIG. 4. As can be seen, the UV transmission for blend no. 2, including both cotton fibers and turmeric, had the lowest transmission rate of the three sets tested. Bottles formed from blend no. 3, including both kenaf fibers and turmeric, exhibited lower UV transmission than those formed of blend no. 6, including kenaf fibers but no turmeric, suggesting that the turmeric prevents UV light from passing through the container sidewall. Beyond the UV range, the differences between the cotton- and kenaf-containing blends was found to be greater with the cotton blend, demonstrating much lower transmission characteristics.

TABLE 8

| Wavelength | Blend No. 2 | Blend No. 3 | Blend No. 6 |
|---|---|---|---|
| (nm) | (% transmitted) | (% transmitted) | (% transmitted) |
| 300 | 0.86 | 3.78 | 4.94 |
| 310 | 1.03 | 4.31 | 5.80 |
| 320 | 1.08 | 4.76 | 6.71 |
| 330 | 1.24 | 5.23 | 7.60 |
| 340 | 1.35 | 5.66 | 8.51 |
| 350 | 1.52 | 6.15 | 9.66 |
| 360 | 1.76 | 7.03 | 10.90 |
| 370 | 1.96 | 7.62 | 11.92 |
| 380 | 1.92 | 8.12 | 12.89 |
| 390 | 2.14 | 8.29 | 13.92 |
| 400 | 2.06 | 8.47 | 14.53 |

### Water Vapor Transmission and Sorption

Three bottles were filled with room temperature distilled water and weighed. The bottles were then placed into a constant temperature environment at 72° F. and 50% relative humidity and weighed once per week over the course of five weeks. Bottles were also tested in the same manner as above except the bottles were filled with an 80/20 mixture of water and alcohol. These bottles were also weighed once per week over the course of five weeks. The results are shown below in Table 9.

The two blends tested exhibited very similar water and alcohol/water vapor transmission rates. After 5 weeks under test for transmission, the bottles were emptied and weighed to determine the amount of water absorbed in the container sidewall. These containers were then weighed weekly over the course of 3 weeks to determine the loss of water and water/alcohol from the saturated sidewall. The results indicate slightly higher sorption of the water/alcohol blend than water.

TABLE 9

| | | | |
|---|---|---|---|
| Blend | Transmission | Sorption | De-Sorption |
| No. | (average g/day) | (grams) | (g/day) |

Water Vapor Transmission and Sorption

| | | | |
|---|---|---|---|
| 2 | 0.04 | 0.15 | 0.01 |
| 3 | 0.04 | 0.18 | 0.02 |

80/20 Water/Alcohol Vapor Transmission and Sorption

| | | | |
|---|---|---|---|
| 2 | 0.04 | 0.24 | 0.02 |
| 3 | 0.03 | 0.16 | 0.01 |

Bottles were also tested for water vapor transmission using ASTM method F1249. For this method, one empty bottle was tested using Mocon equipment at 100° F. and 100% relative humidity and the results were corrected to sea level pressure. The results are shown in Table 10 below.

TABLE 10

| | Result |
|---|---|
| Blend No. | (gm/day) |
| 2 | 0.16 |
| 3 | 0.16 |

### Oxygen Permeation

Bottles were tested for O₂ permeation rate. The bottles were placed onto a Mocon station with epoxy in a 42-48% relative humidity atmosphere on the inside of the container. The outside of the container was exposed to a 72° F., 50% relative humidity environment. The equilibrated oxygen permeation is shown in the table below for each blend tested. For reference, the permeation rate for a PET container would be in the 0.040-0.050 cc/pkg/day range for this type of container.

TABLE 11

| | Result |
|---|---|
| Blend No. | (cc/pkg/day) |
| 2 | 0.066 |
| 3 | 0.065 |
| 6 | 0.066 |

Oxygen permeation was also evaluated using the Mocon headspace technique. In this method, five bottles of each sample number type were prepared for long term oxygen permeation testing by applying a metal washer fixed with a rubber septum onto the container finish. Approximately 50 mL of tap water was added to each container and then the bottles were affixed to a purging system. These bottles were then flushed with 99.999% nitrogen to reduce the internal oxygen concentration below 200 ppm. Once the bottles were purged, the initial oxygen concentration was determined by pulling a small sample from each container and analyzing it on a Mocon PAC CHECK 450 Oxygen Analyzer. The bottles were then stored in a controlled environment at 72° F. and 45-50% relative humidity. The bottles were removed from the chamber and sampled periodically with the Mocon PAC Check 450 to determine the oxygen ingress over time. The averaged results collected to date are shown in Table 12, below and FIG. 5.

TABLE 12

| Blend No. | Day 14 | Day 21 | Day 30 |
|---|---|---|---|
| 3 | 8.6 | 12.7 | 22.8 |
| 7 | 10.3 | 15.3 | 23.4 |

It will be appreciated that the foregoing examples, given for purposes of illustration, are not to be construed as limiting the scope of this disclosure. Although only a few exemplary embodiments have been described in detail above, those skilled in the art will readily appreciate that many modifications are possible in the exemplary embodiments without materially departing from the novel teachings and advantages of the subject matter. Accordingly, all such modifications are intended to be included within the scope of this disclosure. Further, it is recognized that many embodiments may be conceived that do not achieve all of the advantages of some embodiments, yet the absence of a particular advantage shall not be construed to necessarily mean that such an embodiment is outside the scope of the present disclosure.

1. A molded container comprising a polylactide-based composite material, the polylactide-based composite material including
a polylactide-based polymer matrix;
reinforcement fibers, wherein said fibers are derived from a renewable natural resource; and
an inhibitory agent, said inhibitory agent at least partially preventing the passage of a factor across a wall of the container and into the interior of the container, wherein said inhibitory agent is derived from a renewable resource.

2. The molded container of claim 1, wherein the molded container is an injection molded container.

3. The molded container of claim 1, wherein the molded container is an injection blow molded container.

4. The molded container of claim 1, wherein the polylactide-based polymer matrix comprises a polymer blend.

5. The molded container of claim 1, wherein the polylactide-based polymer matrix comprises a polylactide copolymer.

6. (canceled)

7. The molded container of claim 1, wherein the reinforcement fibers are selected from the group consisting of flax, kenaf, and cotton fibers.

8. The molded container of claim 1, wherein the polylactide-based composite material comprises the reinforcement fibers in an amount of less than about 5% by weight of the composite material.

9. The molded container of claim 1, wherein the inhibitory agent is a natural antioxidant.

10. The molded container of claim 9, wherein the antioxidant is turmeric.

11. (canceled)

12. The molded container of claim 1, wherein the inhibitory agent is an anti-microbial agent or an anti-fungal agent.

13. (canceled)

14. (canceled)

15. The molded container of claim 1, wherein the inhibitory agent is released over time from the polylactide-based composite material.

16. A packaging fabric for an agricultural product, said packaging fabric comprising a plurality of yarns formed of a polylactide-based composite material, wherein said polylactide-based composite material includes a polylactide polymer matrix and reinforcing fibers derived from the agricultural product.

17. The packaging fabric of claim 16, wherein the fabric is a woven fabric.

18. The packaging fabric of claim 16, wherein the fabric comprises yarns formed of the polylactide-based composite material.

19. The packaging fabric of claim 16, wherein the agricultural product is cotton.

20. The packaging fabric of claim 16, the polylactide-based composite material further comprising an inhibitory agent, said inhibitory agent at least partially preventing the passage of a factor from a first side of the packaging fabric to a second side of the packaging fabric, wherein said inhibitory agent is derived from a renewable resource.

21. (canceled)

22. A method for forming a molded container comprising:
providing a polylactide-based polymer resin having a moisture content of less than about 50 ppm;
combining the polylactide-based polymer resin with a plurality of reinforcement fibers, said reinforcement fibers being combined with said polylactide-based polymer resin in an amount of less than about 5% by weight of the polylactide-based polymer, wherein said fibers are derived from a renewable resource;
combining the polylactide-based polymer resin with an inhibitory agent, wherein said inhibitory agent is derived from a renewable resource;
molding a mixture comprising the polylactide-based polymer resin, the reinforcement fibers, and the inhibitory agent to form a structure, wherein the inhibitory agent at least partially prevents the passage of a factor across the structure.

23. The method of claim 22, wherein the polylactide-based polymer resin comprises a polymer blend.

24. The method of claim 22, wherein the polylactide-based polymer resin is melt mixed with the reinforcement fibers and the inhibitory agent.

25. The method of claim 22, wherein the polylactide-based polymer resin is solution mixed with the reinforcement fibers and the inhibitory agent.

26. The method according to claim 22, wherein the structure is injection molded.

27. The method according to claim 22, wherein the structure is injection blow molded.

28. The method according to claim 22, wherein the reinforcement fibers are selected from the group consisting of flax, kenaf, and cotton fibers.

29. The method according to claim 22, wherein the inhibitory agent is a natural antioxidant.

30. (canceled)

31. The method according to claim 22, wherein the inhibitory agent prevents electromagnetic radiation in the ultra-violet spectrum from passing across the structure.

32. (canceled)

33. (canceled)
